(19) United States
(12) Patent Application Publication
(10) Pub. No.: US 2009/0216369 A1
(43) Pub. Date: Aug. 27, 2009

(54) METHOD FOR PROCESSING MAILED ITEMS

(75) Inventors: Christine Götz, Brensbach (DE); Torsten Plankert, Dinslaken (DE); Sandra Meuer, Essen (DE); Silvia Buchner, Sprockhövel (DE)

Correspondence Address: International IP Law Group, P.O. BOX 691927, HOUSTON, TX, 77269-1927, US

(73) Assignee: DEUTSCHE POST AG, Bonn, DE (DE)

(21) Appl. No.: 11/917,535

(22) PCT Filed: Jun. 16, 2006
(86) PCT No.: PCT/EP2006/005796

§ 371 Date: Mar. 1, 2008

(30) Foreign Application Priority Data
Jun. 16, 2005 (EP) 05012995.6

(51) Int. Cl. G06F 7/00

(52) U.S. Cl. 700/226

(57) ABSTRACT

An exemplary method for processing mailpieces is adapted to be performed in a data network having a plurality of first processing units situated in at least two mail processing centers, the plurality of first processing units having a first functionality, and having at least one second processing unit having a second functionality, the plurality of first processing units and the at least one second processing unit being connected to each other within the data network, wherein images of at least one surface of the mailpieces have been recorded, and wherein mailing data associated with the mailpieces has been ascertained on the basis of the recorded images. The exemplary method comprises storing connection information for establishing data connections to the plurality of first processing units in at least one list, performing a load balancing method to determine connection information for establishing a data connection to a one of the plurality of first processing units using the at least one list, sending the connection information to the at least one second processing unit, establishing a data connection between the one of the plurality of first processing units and the at least one second processing unit using the connection information, and transmitting an image of a surface of a mailpiece via the data connection.

### CROSS REFERENCE TO RELATED APPLICATIONS

Pursuant to 35 U.S.C. § 371, this application is the United States National Stage Application of International Patent Application No. PCT/EP2006/005796, filed on Jun. 16, 2006, the contents of which are incorporated by reference as if set forth in their entirety herein, which claims priority to EP Patent Application No. 05012995.6, filed Jun. 16, 2005, the contents of which are incorporated by reference as if set forth in their entirety herein.

### BACKGROUND

The invention relates to a method for processing mailpieces in which images of the surfaces of the mailpieces are recorded, and mailing data that is associated with the mailpieces is ascertained from the recorded images in processing units having different functionalities.

For purposes of transporting mailpieces to their destination addresses, the mailpieces are normally collected at the outgoing location in a distribution center of a postal service provider and, within the scope of the outgoing sorting, are associated with the distribution center at the destination. Then, at the destination, sorting is carried out according to the delivery zones of the destination and according to the delivery sequence within the delivery zones, that is to say, according to the sequence in which the destination addresses are serviced by a deliverer.

In this context, the processes for sorting the mailpieces are highly automated, whereby a plurality of systems are employed for sorting and for ascertaining the information required for the sorting in a distribution center.

As a rule, first of all, an image of the mailpiece surface is recorded in a scanning device, from which mailing data is ascertained in a plurality of processing units. As a rule, especially a coding system is present in a distribution center and the recipient address is read in within said coding system. Here, the coding system comprises multiple automatic address readers and multiple video coding stations at which the address is ascertained by the video coding personnel if it was not possible for it to be read automatically. Moreover, automatic processing units are used especially in order to ascertain the weight and the dimensions of a mailpiece as well as to check the postage.

A difficulty here lies in the planning of the machines that have a certain functionality and that are needed for processing the mail, since the mail volume to be processed is generally not precisely known. Moreover, the mailpieces are not delivered to a distribution center continuously, so that fluctuations in the required processing capacity constantly occur.

Thus, in a distribution center, sufficient numbers of processing units always have to be available to process the maximum mail volume that has to be processed so that, even if an especially high mail volume occurs, the distribution center has a sufficient processing capacity. However, this is economically very disadvantageous since it hardly ever happens that all of the available machines have to be used.

This applies especially to video coding stations whose operation, on the one hand, is associated with an especially high expenditure and for which, on the other hand, only very imprecise predictions can be made about the mail volume that will have to be processed since this fluctuates not only with the mail volume in the distribution center but also with the reading rate of the automatic address readers.

Therefore, when there is an especially high mail volume, especially in the case of the video coding stations, the capacities present in a distribution centerare often not sufficient to process all of the mail, which can then lead to delays in the delivery.

For example, in German Preliminary Published Application DE 43 24 255 A1, it has already been proposed to carry out the video coding in a video coding center if the capacity in a given distribution center is not sufficient.

### SUMMARY OF THE INVENTION

It is the objective of the invention to create a method of the above-mentioned type in which the number of mailpieces that can be mechanically processed in mail processing centers can be increased, especially by using the capacity of the mail processing centers.

According to an exemplary embodiment of the present invention, it is provided that a method is carried out in such a way that first processing units having a first functionality, which are situated in at least two mail processing centers, and at least one second processing unit having a second functionality are connected to each other within a data network, whereby connection information for establishing data connections to the first processing units is stored in a service list in a load balancing unit, in that, by means of a load balancing method, the load balancing unit determines on the basis of the service list connection information for establishing a data connection to a first processing unit and sends it to the second processing unit, in that the second processing unit, establishes a data connection to the first processing unit using the connection information, and in that the second processing unit transmits at least the image of the surface of the mailpiece to the first processing unit or retrieves it from the first processing unit.

Within the scope of the invention, the term processing units is to be understood in its broadest sense and especially comprises all systems that are provided within a mail processing center of a postal service provider for processing or handling mailing data.

Within the scope of the invention, a mail processing center can be any processing center for processing the physical mailpiece and/or the image of the surface of the mailpiece that is operated by a postal service provider. For example, it can be a distribution center in which especially the incoming or outgoing sorting of the mailpieces is carried out, or it can be a video coding center.

In the method according to an exemplary embodiment of the invention, the first processing units and the second processing unit are connected to each other within a data network so that a data exchange spanning multiple processing centers is possible.

Moreover, the information needed for establishing the connection to first processing units is stored in a service list, as a result of which these units are grouped into a processing unit group spanning multiple processing centers.

Especially advantageously, a load balancing among the processing units is carried out in this group, which can especially be done likewise spanning multiple processing centers.

A video coding center can also be integrated in a simple manner into a group of mail processing centers.

Therefore, the processing units of several mail processing centers are available for ascertaining mailing data for mailpieces that are sorted in a specific mail processing center, and the capacity of these processing units can be utilized evenly by means of the method according to an exemplary embodiment of the present invention.

In case of an especially high mail volume in a first mail processing center for whose processing the number of first processing units present in the mail processing center is not sufficient, the processing can thus also be carried out in the first processing units of another mail processing center in which the mail volume is smaller.

Consequently, on the basis of the method according to the invention, the capacities available in the mail processing centers can be utilized more fully and efficiently so that even an especially high mail volume in a mail processing center can be completely processed without this processing center having to have a sufficient number of processing units having a specific functionality in order to process the maximally occurring mail volume.

The processing units having the first functionality that are grouped into the processing unit group can be, for example, video coding stations.

However, other processing units can also be grouped into a logical group, whereby fundamentally, multiple processing unit groups can also exist for different functionalities and each processing unit in a mail processing center can also be integrated into such a group so that, for each functionality needed in a mail processing center, a processing unit group exists and a load balancing spanning multiple distribution centers can be carried out for any desired functionality.

Moreover, the method according to the invention has the advantage that the image of a mailpiece is transmitted directly by the second processing unit to a first processing unit or is retrieved directly from a first processing unit, that is to say, the communication between the second processing unit and the first processing unit takes place here in a decentralized manner within the scope of a so-called peer-to-peer connection.

In an advantageous embodiment of the invention, the images of the mailpiece surfaces are contained in mailpiece data records that are augmented in the processing units by the mailpiece data ascertained from the images.

In this manner, the image of the surface of the mailpiece can be transmitted to the various processing units in a prescribed order, whereby the processing units consecutively augment the mailpiece data record so that, after the mailpiece data record has been processed in the last processing unit, a mailpiece data record is present with all of the mailpiece data that is needed for the sorting.

Preferably, it is provided that the second processing unit transmits the mailpiece data record to the first processing unit or retrieves the mailpiece data record from the first processing unit.

In an especially preferred embodiment of the invention, it is provided that, during the load balancing method, an order is prescribed in which the first processing units are loaded consecutively.

This corresponds to the so-called round-robin method for performing a load balancing.

In order to ensure here that the processing unit ascertained on the basis of the prescribed order is indeed available, in another advantageous embodiment of the invention, it is provided that, by means of a status query, the load balancing unit determines the status of a first processing unit ascertained according to the order and, as a function of the status of the first processing unit, transmits the connection information to the second processing unit.

Preferably, it is provided here that the load balancing unit only transmits to the second processing unit the connection information for establishing a data connection to the first processing unit when, on the basis of the response to the status query, the availability of the first processing unit has been ascertained.

Preferably, it is also provided that the load balancing unit sends a status query to the first processing unit that follows in the order prescribed during the load balancing method when, on the basis of the response to the status query, it has been ascertained that a first processing unit is not available.

In another advantageous embodiment of the invention, it is provided that the second processing unit transmits a query for transmitting connection information to the load balancing unit.

In order to be able to systematically establish a data connection to a first processing unit in a specific mail processing center, in an advantageous embodiment of the invention, it is provided that the queries for transmitting connection information contain information about a mail processing center.

Advantageously, during the load balancing method, only the first processing units of the mail processing center indicated in the query for transmitting connection information are taken into account.

In this manner, the connection information for establishing a data connection to a processing unit in a specific mail processing center, for example, in the mail processing center in which the physical mailpiece is being processed, can be systematically made available to the second processing unit.

In an advantageous embodiment of the invention, a plurality of service lists is stored in the load balancing unit, whereby the service lists each contain connection information for establishing a data connection to processing units having the same functionality.

Preferably, the query for transmitting connection information here comprises information about the functionality of the first processing unit.

As a result, the second processing unit can request from the load balancing unit connection information for establishing a data connection to a first processing unit having a special functionality that is necessary, for example, for a subsequent processing step.

Advantageously, on the basis of the information about the functionality of the first processing unit, the load balancing unit ascertains from the plurality of service lists the service list containing the connection information for establishing a data connection to the first processing units having the first functionality.

In another advantageous embodiment of the invention, it is provided that a first processing unit logs on to a management unit, whereby the management unit stores in the service list the connection information for establishing a data connection to the first processing unit.

Moreover, in an advantageous embodiment of the invention, it is provided that a first processing unit logs off from the management unit, whereby, at the time of the logoff, the management unit deletes the connection information of the processing unit from the service list containing the connection information for establishing a data connection to the first processing units.

Here, the log-off can be carried out especially when the first processing unit is not available, for example, due to maintenance work.

In this manner, the management unit always has current information about the processing units that are fundamentally available.

Preferably, it is provided that the management unit transmits the service list to the load balancing unit and that the load balancing unit stores the service list.

In order for the load balancing unit to always have a service list with the currently available processing units, in a preferred embodiment of the invention, it is also provided that the management unit sends an updated service list to the load balancing unit at regular intervals.

Consequently, even if the management unit malfunctions, the load balancing unit is able to ascertain connection information from the stored service list.

Preferably, a management unit is present in each mail processing center, and a first processing unit logs on to or off from the management unit that is situated in the same mail processing center as the first processing unit.

In this manner, the mail processing centers can be operated autonomously.

In order for the connection information for establishing a data connection to the first processing units in a specific mail processing center to also be available in other mail processing centers, in another preferred embodiment of the invention, it is provided that the management units exchange the connection information for establishing a data connection to the first processing units that are logged on to the management units.

In an especially advantageous embodiment of the invention, the load balancing unit is functionally and unambiguously associated with the second processing unit.

Consequently, in this embodiment of the invention, the second processing unit has its own load balancing unit so that the load balancing is takes place here in a decentralized manner.

As a result, the function of the entire system can be maintained, even if a load balancing unit malfunctions.

### BRIEF DESCRIPTION OF THE DRAWINGS

FIG. 1 is a schematic representation of a network with networked processing units and with a management unit in two mail processing centers in accordance with an exemplary embodiment of the present invention;

FIG. 2 is a schematic representation of the structure of a management unit in accordance with an exemplary embodiment of the present invention;

FIG. 3 is a schematic representation of various processing unit groups in accordance with an exemplary embodiment of the present invention;

FIG. 4 is a schematic representation with a management unit, a load balancing unit and several processing units in accordance with an exemplary embodiment of the present invention; and

FIG. 5 is a schematic representation with a management unit and several processing units, each of which has a load balancing unit in accordance with an exemplary embodiment of the present invention.

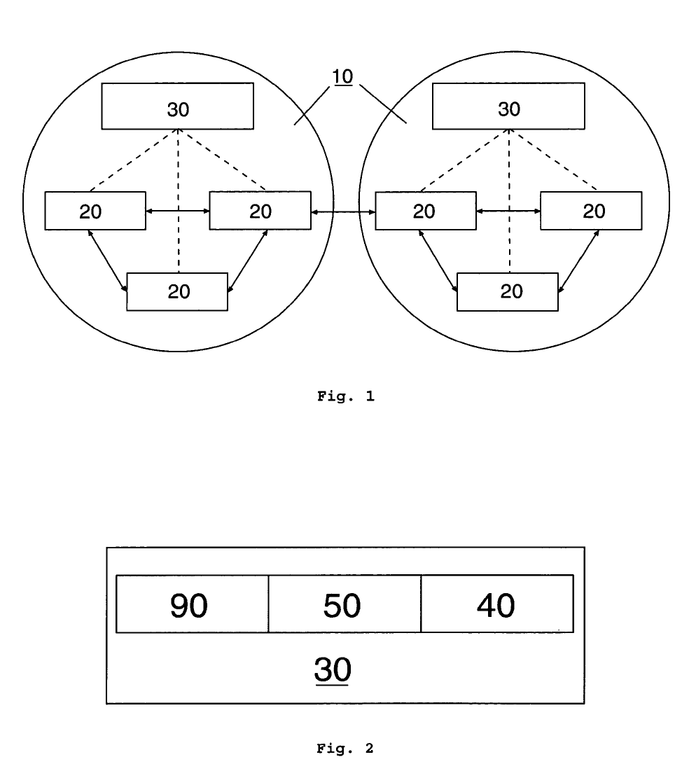

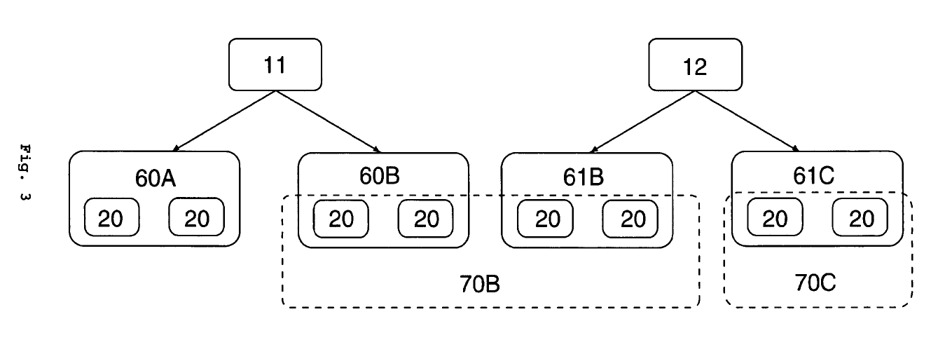

### DETAILED DESCRIPTION OF SPECIFIC EMBODIMENTS

When mailpieces are processed, outgoing sorting is normally carried out in a distribution center at the place of origin of the mailpieces and incoming sorting is carried out in a distribution center at their destination. During the outgoing sorting, the mailpieces are sorted at the distribution centers according to the destinations, whereas the incoming sorting comprises sorting the mailpieces according to the delivery sequence at the destination.

Address information as well as further data that is relevant for the sorting or for the transport of the mailpieces such as, for example, whether the postage is correct, are ascertained by processing units that are connected data-wise to the sorting devices.

An image of the mailpiece surface is transferred to the processing units from which, depending on their functionality, they ascertain the information needed for the sorting. Here, a distinction has to be made between online processing, in which the mailpieces are located within a storage segment in the sorting machine during the processing of the image, and offline processing, in which the mailpieces are not situated in the sorting machine during the processing of the image.

During the offline processing, the image or the information ascertained from the image is associated with the physical mailpiece by means of an unambiguous ID code that is printed onto the mailpiece and associated with the image.

Address information is ascertained in a coding system comprising several processing units. These are especially automatic address readers in which the address information is automatically read by means of OCR software and a video coding system with multiple video coding stations to which the image of the mailpiece surface is transferred if a reading attempt in an automatic address reader is unsuccessful.

Moreover, the image is fed to an automatic postage reader in which an automatic postage verification is carried out, and additional processing units can be provided such as, for example, automatic forwarding elements in which it is ascertained whether there is a forwarding order for the mailpiece.

The processing units can be operated in the distribution centers of a postal service provider or in other mail processing centers.

In a mail processing center, as a rule, multiple processing units having the same functionality are operated so as to be able to process the mail volume as completely as possible and so as not to have to totally interrupt the production in case of the malfunction of one processing unit.

The present invention is based on the realization that the processing of the image—in contrast to the processing of the physical mailpiece—does not have to be carried out at its specific location but rather that the processing can fundamentally also be carried out by the processing units of a mail processing center in which the mailpiece is not physically present and that a load balancing spanning multiple processing centers can also be carried out.

On the basis of this realization, it is provided that, at least for the processing units having certain functionalities, processing unit groups spanning multiple processing centers can be created within which especially a load balancing spanning multiple processing centers is carried out so that the capacity of the processing units present in the mail processing centers can be uniformly utilized.

Here, it is especially advantageous if at least one video coding group spanning multiple processing centers is created since especially the video coding of the delivery addresses is very time-consuming and personnel-intense. In this manner, it is also easy to integrate a video coding center, that is to say, a mail processing center where exclusively video coding stations are operated, into the video coding group.

Fundamentally, however, processing unit groups spanning multiple distribution centers can be set up for processing units having any desired functionality.

As schematically shown in FIG. 1 with reference to the example of two mail processing centers 10, it is provided that the likewise depicted processing units 20 by way of an example in different mail processing centers 10 are connected to each other within a data network.

Here, they make their functionalities available within the network in the form of so-called distributed CORBA objects that can be used or called by other processing units 20. The way in which this is done is known to the person skilled in the art, in principle.

The data communication within the network illustrated in FIG. 1 by the solid lines, that is to say, the exchange of mailing data, preferably takes place directly between the processing units 20.

Consequently, the network is a so-called peer-to-peer network in which, on the one hand, the processing units 20 make services available and in which, on the other hand, they make use of services of other processing units 20.

The sorting machines or control systems for the sorting machines that feed in the acquired images of the mailpiece surfaces into the data network and to which the information ascertained from the image is transmitted for purposes of sorting the mailpieces are likewise incorporated into the data network.

Here, it is provided that, during the processing of a mailpiece, first of all, a mailing data record containing the image of the mailpiece surface is generated, and said mailpiece data record is augmented by the processing units 20 by mailing data, especially by information ascertained from the image.

The complete mailing data record, that is to say, containing all of the relevant information, is then transmitted to the control systems of the sorting machines or the group of sorting machines provided for the sorting so that the mailpieces can be sorted on the basis of the mailing data.

In addition to the image of the mailpiece surface, the mailing data record also includes further data elements such as, for example, the postal code, the name, the street and the house number of the recipient as well as data elements pertaining to the correctness of the postage. Moreover, the mailing data record contains information of the distribution center where the mailpiece in question was received.

Preferably, the mailing data record likewise contains an unambiguous ID number with which the appertaining mailpiece is also provided. During the sorting of the mailpiece, the ID number is recorded in the sorting machine and the mailing data record containing the read-in ID number is ascertained from which the mailing data is then read out and on the basis of which the sorting is carried out.

The values of the data elements are ascertained by the processing units 20 on the basis of their functionalities and stored in the mailing data record, whereby the mailing data record is consecutively transferred in a prescribed process order to the processing units 20 having different functionalities.

Here, transfer conditions are specified for the values of the data elements and, if such conditions are fulfilled, the mailing data record is transferred from a processing unit 20 having a first functionality to a processing unit 20 having a second functionality.

If one looks, for example, at the coding of the delivery address as a partial process within the entire process order, then the mailing data record is first transmitted to an automatic address reader. If the delivery address cannot be ascertained within a prescribed period of time in this automatic address reader, then the mailing data record is transferred to a video coding station. Otherwise, it is sent from the automatic address reader, for example, to a postage reader that checks the correctness of the postage on the basis of the ascertained delivery address.

In order to transfer the mailing data record to a processing unit 20 that follows in the process order or to retrieve it from a processing unit 20 that precedes in the process order, connection information is needed that especially comprises the network address of this processing unit 20 as well as the port address of the service it provides.

This information is provided to the processing units 20 by a management unit 30, whereby each mail processing center 10 has its own management unit 30. The management communication for transmitting the connection information is indicated in FIG. 1 by broken lines.

In the management unit 30 of a mail processing center 10, especially the processing units 20, which are operated in this mail processing center 10, are registered together with their connection information.

Moreover, relative to the processing units 20 that are integrated into a processing unit group spanning multiple processing centers, a synchronization of the management units 30 of various mail processing centers 10 is performed in which the registration information for these processing units 20 is exchanged among the management units 30.

In this manner, the processing units 20 of a first mail processing center 10 can retrieve connection information for establishing a data connection to a processing unit 20 in another mail processing center 10 from the management unit 30 of the first mail processing center 10.

Within the management unit 30, the connection information of the registered processing units 20 is managed in a grouping component 40 in which processing units 20 having the same functionality are grouped to form a processing unit group.

A service list for each processing unit group is stored in the grouping component 40, said list containing the connection information for the processing units 20 of the processing unit group.

Moreover, for each processing unit group or for each service list, it is specified whether this is a local or a global processing unit group.

Here, a data connection to the processing units 20 of a global processing unit group can also be established from outside of the mail processing center 10 in which the processing units 20 are located, whereas only those processing units 20 that are operated within the same mail processing center 10 can establish a data connection to the local processing unit groups.

Moreover, for each processing unit 20, it can be individually specified whether it is locally or globally available.

Consequently, a global processing unit group within a mail processing center 10 can also include processing units 20 that can only be accessed locally. Here, the term global is taken to mean a processing unit group comprising at least one processing unit 20 that is globally accessible.

In order to be registered in the grouping component 40 within a processing unit group, a processing unit 20 preferably registers at the management unit 30.

During the logon, registration information is transmitted to the management unit 30, said information indicating the functionality of the processing unit 20 that is logging on, the network address associated with it as well as the port address of the service it provides. Furthermore, during the logon, a processing unit 20 also transmits information to the management unit 30 as to whether it is to be locally or globally accessible.

This registration information is evaluated within the management unit 30 by the grouping component 40, whereby the processing unit 20 that is logging on is associated with a processing unit group in accordance with its functionality and the connection information is stored in the service list for this processing unit group.

In the service list, the connection information is provided with a note as to whether the processing unit 20 is locally or globally accessible.

If no processing unit group exists for the functionality of the logging on processing unit 20, then such a group with an appertaining service list is drawn up.

Moreover, processing units 20 log off at the management unit 30 if they are no longer to be available for processing mailpiece data records.

A logoff is sent to the management unit 30, for example, when maintenance work is to be done to a processing unit 20 or if a processing unit 20 in a mail processing center 10 is being permanently removed.

In the case of video coding stations, it is especially also provided that they log off from the management unit 30 of the mail processing center 10 in which they are being operated when they are left by the video coding personnel, for example, at the time of a shift change.

The logoff message sent to the management unit 30 preferably contains the registration information that is also transmitted to the management unit 30 during the logon.

On the basis of the information about the functionality of the processing unit 20 contained in the registration information, the grouping component 40 ascertains the service list of the processing unit group with which the processing unit 20 is associated.

Then, the connection information that is contained in the registration information that was received in the management unit 30 with the logoff message is deleted from the ascertained service list.

If, after this connection information has been deleted, no more connection information is contained in the service list, then this list is likewise deleted.

When a logged-off processing unit 20, for example, after the end of the maintenance work or, in the case of a video coding station—when it is again occupied with personnel—is once again available for the processing of mailpiece data records, then it logs on to the management unit 30 again so that its connection information is integrated into the appropriate service list again in the manner described above.

The registration information of the globally accessible processing units 20 registered in the various mail processing centers 10 is exchanged among the management units 30 of the various mail processing centers 10 within the scope of a synchronization procedure.

Here, the exchanged registration information comprises the connection information and the functionality of the registered globally accessible processing units 20 of a mail processing center 10 and thus allow especially an association between the connection information of a processing unit 20 and its functionality.

The synchronization is preferably performed within the scope of so-called multicast transmission, a procedure which, in principle, is known to the person skilled in the art.

A management unit 30 addresses the registration information stored in its grouping component 40 for the globally accessible processing units 20 to a multicast address specified in the data network via which the registration information is fed to the management units 30 in the other mail processing centers 10.

During the synchronization, the registration information that was transmitted by other management units 30 is evaluated in the grouping component 40 of a management unit 30, and the contained connection information is integrated into the unit's own corresponding service lists.

If no corresponding service lists or processing unit groups are present in the mail processing center 10 for one or more processing units 20 whose registration information is received in a mail processing center 10 within the scope of the synchronization of a management unit 30, then the corresponding service lists are created in the grouping component 40 of the management unit 30, which is also provided for during the logon of a processing unit 20 for whose functionality no service list exists.

Accordingly, the global service lists are likewise deleted which are present in a grouping component 40 and in which no connection information for processing units 20 of the unit's own mail processing center 10 are stored and which are not received during a synchronization procedure.

So that the current service lists for the global processing unit groups are always present in each mail processing center 10, it is provided that the synchronization is performed at regular intervals.

Moreover, as an alternative or additionally, it can be provided that registration information of a processing unit 20 is sent from a management unit 30 in a mail processing center 10 to the management units 30 of the other mail processing centers 10 when this processing unit 20 logs on or off.

Consequently, in the above-mentioned manner, some or all of the processing units 20 of a mail processing center 10 can be integrated into a local processing unit group, in accordance with their functionality. Furthermore, global processing unit groups can be created for one or more prescribed functionalities, spanning multiple distribution centers.

In FIG. 3, this is illustrated for two mail processing centers 11 and 12. In the situation shown by way of an example in FIG. 3, the processing unit group 60A exists for the functionality A in the location 11 and the processing unit group 60B exists for the functionality B, whereby the processing units 20 of the processing unit group 60A are only locally accessible whereas the processing units 20 of the processing unit group 60B are globally accessible.

The processing unit groups 61B and 61C exist for the functions B and C in the mail processing center 12, whereby the processing units 20 of the two processing unit groups 61B and 61C are globally accessible.

All in all, this results in an exclusively local processing unit group 60A for the functionality A, a global processing unit group 70B for the functionality B consisting of the local processing unit groups 60B and 61B, as well as a global processing unit group 70C for the functionality C consisting only of the local processing unit group 61C.

Service lists for the functionalities B and C are stored in the grouping component 40 of the management unit 30 of the mail processing center 12. In addition, a service list for the functionality A is present in the grouping component 40 of the management unit 30 of the mail processing center 11.

In addition to the management of the service list, another task of the management unit 30 of a mail processing center 10 is the management of periods of validity (“lease management”) for the registered processing units 20 of the mail processing center 10. The lease management is carried out by a lease manager 50 of the management unit 30.

The lease management 50 assigns a period of validity to each processing unit 20, whereby the processing units 20 have to log on to the management unit 30 once again or have to send a prescribed signal to the management unit 30 before the expiration of the period of validity, preferably between the expiration of 0.8 times and 0.9 times the period of validity.

If the renewed logon or the signal of a processing unit 20 is absent, this processing unit 20 is automatically logged off after the expiration of the period of validity.

The period of validity has the same length for all of the processing units 20 of a location and starts for each processing unit 20 with its logon to the management unit 30. It is preferably between 100 and 500 seconds and starts anew each time it expires.

A processing unit 20 that has newly logged on to the management unit 30 is notified of the period of validity with a response to the logon.

The lease management prevents that the service list contains connection information for processing units 20 that were not logged off, either inadvertently or else due to an error, even though they are not available for processing mailing data records.

A push-oriented or pull-oriented transmission method can be provided in order to transmit a mailpiece data record from a processing unit 20 having a first functionality to a processing unit 20 that has a second functionality and that follows in the prescribed process order.

In the case of the push-oriented transmission method, the transmission is initiated by the sender of the mailing data record, that is to say, the mailing data record is sent from a first processing unit 20 to a second processing unit 20 that follows in the process order.

In the case of pull-oriented transmission method, the transmission is initiated by the recipient of the mailing data record, that is to say, the second processing unit 20 that follows in the process order retrieves the mailing data record from the first processing unit 20.

In the transmission method provided in each case, the processing unit 20 that is active in the transmission, that is to say, in the case of a push-oriented transmission, the sending processing unit 20 and, in the case of a pull-oriented transmission, the receiving processing unit 20, needs the connection information for establishing a data connection to its communication partner.

The active processing unit 20 retrieves this connection information from a load balancing unit 80 by means of a service request.

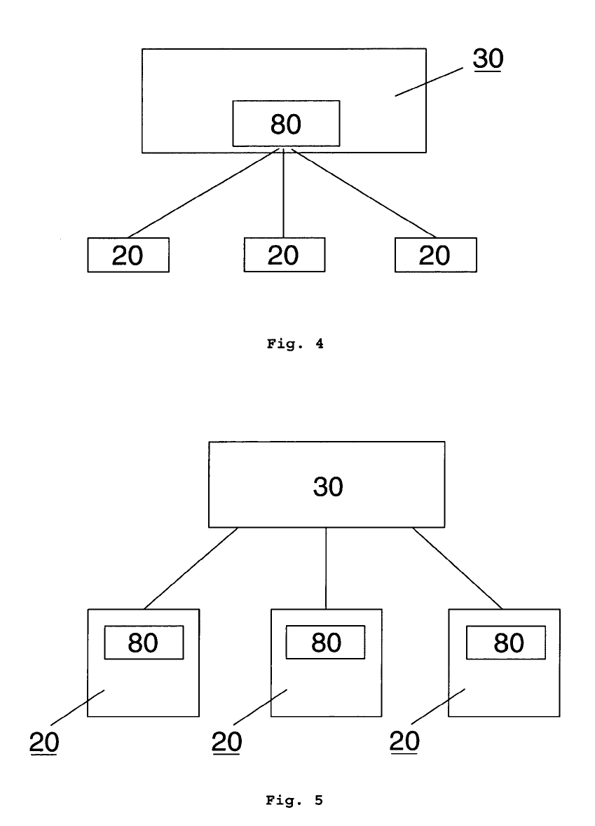

In a first embodiment of the invention, which is shown in FIG. 4, precisely one load balancing unit 80 is present in each mail processing center 10, whereby said load balancing unit 80 is preferably an integral part of the management unit 30 of the mail processing center 10. In this embodiment, all of the service lists of the grouping component 40 are transferred to the load balancing unit 80.

In a second embodiment shown in FIG. 5, each processing unit 20 has its own load balancing unit 80 in which the service lists for the processing unit groups are stored that are relevant for the appertaining processing unit 20.

The second embodiment has the advantage that connection information can be provided to the processing units 20, even in case of a temporary malfunction of the management unit 30, so that the availability of the entire system is enhanced.

In the second embodiment, as shown in FIG. 5, the load balancing units 80 can be operated within the processing units 20 or they can be only functionally and unambiguously associated with the processing units 20 and, for example, integrated into the management unit 30.

The service lists that are relevant for a given processing unit are the service lists containing connection information for the processing units 20 whose services are utilized by the processing unit 20 associated with the load balancing unit 80, that is to say, to which this processing unit 20 transmits mailpiece data records or from which it retrieves mailpiece data records.

In the second embodiment, a load balancing unit 80 retrieves the relevant service lists from the management unit 30, preferably at regular intervals, or else the service lists are transmitted by the management unit 30 at regular intervals.

As an alternative or additionally, it can be provided that the service lists are transmitted to a load balancing unit 80 in case of a change that results due to a logon or logoff of a processing unit 20.

It can likewise be provided that the relevant service lists are retrieved from the management unit 30 on an as-needed basis and are stored for a prescribed period of time. If they are needed again after the end of this period of time, they are once again retrieved by the management unit 30.

The service request that is transmitted from a first processing unit 20 to the load balancing unit 80 of the mail processing center 10 or to its own load balancing unit 80 contains especially information about the functionality of the second processing unit 20 with which a data connection is to be established.

The functionality of the second processing unit 20 arises from the transmission conditions specified within the first processing unit 20 for various processing units 20 that follow in the prescribed process order.

Moreover, in the service request, one or more mail processing centers 10 can be indicated in which the second processing unit 20 is located to which a data connection is to be established.

In this manner, it is made possible that, in spite of the existence of a global processing unit group, mailpiece data records can be processed within specified mail processing centers 10.

Moreover, on the basis of this information, the mailing data records that are processed by a processing unit 20 of a global processing unit group that is not located in the mail processing center 10 in which the physical mailpiece is being processed can be sent back to this mail processing center 10.

When the load balancing unit 80 receives a service request, it first ascertains the service list for the functionality indicated in the service request.

Then, from the ascertained service list, connection information is ascertained by means of a load balancing process.

In a preferred embodiment, the load balancing process is based on the so-called round-robin method, which is fundamentally known to the person skilled in the art.

In this process, the processing units 20 of a processing unit group are cyclically loaded in a prescribed order. For example, if the processing units 1, 2, 3 and 4 are available in a processing unit group, then they are loaded in the order 1, 2, 3, 4, 1, 2, 3, 4, etc.

If a global service list has been ascertained in this process from which the connection information is ascertained, and if the service request contains information about a specific mail processing center 10, then the round-robin method is modified in such a way that only connection information for processing units 20 of the indicated mail processing center 10 is taken into account and that the other connection information contained in the service list is skipped.

At a processing unit 20 whose connection information has been ascertained by means of the round-robin method, the load balancing unit 80 then sends a status query in order to determine the availability of this processing unit 20.

If the processing unit 20 then feeds back the status “logged on”, then the load balancing unit 80 transmits the connection information for this processing unit 20 within a response to the service request to the processing unit 20 from which the service request had come.

If the processing unit 20 to which the status query was sent reports the status “overloaded”, “temporarily logged off” or “logged off”, or if no response to the status query is received within a specified period of time, then the load balancing unit 80 ascertains the next connection information in the service list on the basis of the round-robin method and, once again, checks the status of the appertaining processing unit 20.

The status “temporarily logged off” is provided so that processing units 20 can be taken out of operation for a short period of time, for example, during maintenance work that is to be carried out quickly without a need to log off from the management unit 30.

Connection information for processing units 20 for which the status “overloaded” or “temporarily logged off” has been ascertained or from with no response to the status query has been received within a specified period of time is taken into account during subsequent service requests, once again in accordance with the round-robin method.

Connection information for processing units 20 for which the status “logged off” has been ascertained is preferably only taken into account again when the load balancing unit 80 has received an updated service list from the management unit 30 or from its grouping component 40 in which this connection information is contained.

Using the connection information received from the load balancing unit 80, the processing unit 20 from which the service request came establishes a data connection to another processing unit 20.

Depending on whether a push-oriented or pull-oriented data transmission is provided, the mailing data record is transmitted to the other processing unit 20 or else it is retrieved from the other processing unit 20.

If no processing unit 20 corresponding to the service request can be ascertained, then an error message is transmitted to the processing unit 20 from which the service request came.

This error message also contains information about the reason why no processing unit 20 corresponding to the service request could be ascertained.

If the reason is that all of the processing units 20 registered in the management unit 30 that meet the service request have fed back the status “overloaded” or “temporarily logged off” and are thus only briefly unavailable, then, in a preferred embodiment of the invention, it is provided that the processing unit 20 from which the service request came can register for a notification event in the event handler 90 of the management unit 30 of the same mail processing center 10.

During the registration, the service request is transmitted to the event handler 90.

If at least one processing unit 20 corresponding to the service request is available again, then a message is transmitted to the processing unit 20.

The message can contain the connection information for the processing unit 20 that is available again, so that a data connection can be established to this processing unit 20. However, it can also be provided that a processing unit 20 once again transmits the service request to the load balancing unit 80 when the message has been received.

Moreover, a message is also transmitted to a processing unit 20 that is registered in the event handler 90 for a notification event when all of the processing units 20 that correspond to the service request have logged off.

### LIST OF REFERENCE NUMERALS

10, 11, 12 mail processing center
20 processing unit
30 management unit
40 grouping component
50 lease manager
60A local processing unit group for the functionality A
60B, 61B local processing unit group for the functionality B
61C local processing unit group for the functionality C
70B processing unit group for the functionality B
70C processing unit group for the functionality C
80 load balancing unit
90 event handler

1-20. (canceled)

21. A method for processing mailpieces in a data network having a plurality of first processing units situated in at least two mail processing centers, the plurality of first processing units having a first functionality, and having at least one second processing unit having a second functionality, the plurality of first processing units and the at least one second processing unit being connected to each other within the data network, wherein images of at least one surface of the mailpieces have been recorded, and wherein mailing data associated with the mailpieces has been ascertained on the basis of the recorded images, the method comprising:
storing connection information for establishing data connections to the plurality of first processing units in at least one list;
performing a load balancing method to determine connection information for establishing a data connection to a one of the plurality of first processing units using the at least one list;
sending the connection information to the at least one second processing unit;
establishing a data connection between the one of the plurality of first processing units and the at least one second processing unit using the connection information; and
transmitting an image of a surface of a mailpiece via the data connection.

22. The method according to claim 21, comprising storing mailpiece data ascertained from the image of the surface of the mailpiece in a mailpiece data record that also contains the image of the surface of the mailpiece.

23. The method according to claim 22, comprising transmitting the mailpiece data record via the data connection.

24. The method according to claim 21, comprising prescribing an order in which the plurality of first processing units are loaded during the load balancing method.

25. The method according to claim 24, comprising:
performing a status query to determine a status of the one of the plurality of first processing units according to the order; and
transmitting the connection information to the at least one second processing unit as a function of the status of the one of the plurality of first processing units.

26. The method according to claim 24, comprising:
performing a status query to determine a status of the one of the plurality of first processing units according to the order; and
transmitting the connection information to the at least one second processing unit if the status of the one of the plurality of first processing units indicates that the one of the plurality of first processing units is available.

27. The method according to claim 24, comprising:
performing a status query to determine a status of the one of the plurality of first processing units according to the order; and
performing a status query to determine a status of a second one of the plurality of first processing units according to the order if the status of the one of the plurality of first processing units indicates that the one of the plurality of first processing units is unavailable.

28. The method according to claim 21, comprising issuing a query from the at least one second processing unit to a load balancing unit that performs the load balancing method, the query relating to the transmission of connection information.

29. The method according to claim 21, comprising performing a query for transmitting connection information, the query comprising information about a mail processing center in which the one of the plurality of first processing units is located.

30. The method according to claim 21, comprising considering only a subset of the plurality of first processing units during the load balancing method, the subset of the plurality of first processing units being located in a particular one of the at least two mail processing centers.

31. The method according to claim 21, wherein the at least one list comprises a first list for storing connection information for establishing data connections between processing units having the first functionality, and a second list for storing connection information for establishing data connections between processing units having the second functionality.

32. The method according to claim 31, comprising performing a query for transmitting connection information, the query including a request for information about a functionality of the one of the plurality of first processing units.

33. The method according to claim 32, comprising selecting the first list as a source of connection information or the second list as a source of connection information depending on the information about the functionality of the one of the plurality of first processing units received from the query.

34. The method according to claim 21, wherein the one of the plurality of first processing units logs on to a management unit to obtain the connection information contained in the at least one list.

35. The method according to claim 34, wherein the one of the plurality of first processing units logs off from the management unit, the management unit deleting connection information relating to the one of the plurality of first processing units in response thereto.

36. The method according to claim 34, wherein the management unit transmits the at least one list to a load balancing unit that performs the load balancing method, the load balancing unit storing the at least one list.

37. The method according to claim 36, wherein the management unit sends an updated version of the at least one list to the load balancing unit at regular intervals.

38. The method according to claim 21, wherein each of the at least two mail processing centers contains a management unit, the one of the plurality of first processing units being adapted to log on to the management unit that is located in the same mail processing center as the one of the plurality of first processing units.

39. The method according to claim 38, wherein the management units exchange connection information for establishing a data connection to any of the plurality of first processing units that are logged on to the respective management unit.

40. The method according to claim 21, wherein the load balancing method is performed by a load balancing unit that is functionally and unambiguously associated with the at least one second processing unit.

41. A data network that is adapted to process mailpieces, the data network having a plurality of first processing units situated in at least two mail processing centers, the plurality of first processing units having a first functionality, the data network having at least one second processing unit having a second functionality, the plurality of first processing units and the at least one second processing unit being connected to each other within the data network, wherein images of at least one surface of the mailpieces have been recorded, and wherein mailing data associated with the mailpieces has been ascertained on the basis of the recorded images, the data network comprising:
means for storing connection information for establishing data connections to the plurality of first processing units in at least one list;
means for performing a load balancing method to determine connection information for establishing a data connection to a one of the plurality of first processing units using the at least one list;
means for sending the connection information to the at least one second processing unit;
means for establishing a data connection between the one of the plurality of first processing units and the at least one second processing unit using the connection information; and
means for transmitting an image of a surface of a mailpiece via the data connection.

42. A tangible machine-readable medium that is adapted to be used in a data network that processes mailpieces, the data network having a plurality of first processing units situated in at least two mail processing centers, the plurality of first processing units having a first functionality, the data network having at least one second processing unit having a second functionality, the plurality of first processing units and the at least one second processing unit being connected to each other within the data network, wherein images of at least one surface of the mailpieces have been recorded, and wherein mailing data associated with the mailpieces has been ascertained on the basis of the recorded images, the tangible machine-readable medium comprising:
machine-readable instructions adapted to store connection information for establishing data connections to the plurality of first processing units in at least one list;
machine-readable instructions adapted to perform a load balancing method to determine connection information for establishing a data connection to a one of the plurality of first processing units using the at least one list;
machine-readable instructions adapted to send the connection information to the at least one second processing unit;
machine-readable instructions adapted to establish a data connection between the one of the plurality of first processing units and the at least one second processing unit using the connection information; and
machine-readable instructions adapted to transmit an image of a surface of a mailpiece via the data connection.
